(19) United States
(12) Patent Application Publication
(10) Pub. No.: US 2024/0309195 A1
(43) Pub. Date: Sep. 19, 2024

(54) System And Method For Photopolymerizing Electrophoretic Gels

(71) Applicant: EMD Millipore Corporation, Burlington, MA (US)

(72) Inventors: Kevin Wu, Burlington, MA (US); Kelly Wolfe, Burlington, MA (US); Anja Dedeo, Burlington, MA (US); Ryan Amara, Burlington, MA (US); Gerard Libby, Burlington, MA (US); Paul Sydlowski, Burlington, MA (US); Katelyn Kavanaugh, Burlington, MA (US); Trisha Bailey, Burlington, MA (US); Nathan T. Allen, Burlington, MA (US)

(21) Appl. No.: 18/578,419

(22) PCT Filed: Aug. 22, 2022
(86) PCT No.: PCT/US2022/041012

§ 371 Date: Jan. 11, 2024

Related U.S. Application Data
(60) Provisional application No. 63/236,020, filed on Aug. 23, 2021.

(51) Int. Cl. C08L 33/26; C08J 9/28; G01N 27/447

(52) U.S. Cl. CPC C08L 33/26; C08J 9/28; G01N 27/44747; C08J 2333/26

(57) ABSTRACT

An acrylamide gel formulation for use in electrophoresis, and a system and method for electrophoretic gel casting. In some embodiments, the system comprises a UV-Vis curing light source, and an acrylamide formulation that allows a resolving gel and a stacking gel to be photopolymerized in a single step. In some embodiments, the resolving solution formulation comprises acrylamide and bis-acrylamide, Bis-Tris buffering agent, and lithium phenyl-2, 4, 6-trimethylbenzoyl-phosphinate (LAP) as a water-soluble photoinitiator, which allows the solution to be photopolymerized using UV radiation within a certain wavelength. In some embodiments, a dilution buffer formulation comprises acrylamide and bis-acrylamide, Bis-Tris buffering agent, and lithium phenyl-2, 4, 6-trimethyl-benzoyl-phosphinate (LAP). The dilution buffer may be added to the resolving solution in a selected amount in order to modify the concentration of the acrylamide to a desired concentration.

This application claims priority of U.S. Provisional Application Ser. No. 63/236,020 filed Aug. 23, 2021, the disclosure of which is incorporated herein by reference in its entirety.

### BACKGROUND OF THE INVENTION

The use of gel electrophoresis, such as polyacrylamide gel electrophoresis (PAGE) is a ubiquitous technique for the separation of biological materials. Nonbiological materials can also be separated using gels or other chromatographic supports as well, but the scope of effort with regard to biologicals is greater. Typical applications include separation of nucleic acid fragments of various sizes either in the context of sequence determination; in the detection of polymorphisms; or verification of sizes in other contexts. Also frequently conducted are separations of proteins (e.g., by SDS-PAGE, where sodium dodecyl sulfate is used) glycoproteins, protein fragments and application of gel separations as verification of homogeneity or purity, identification of post translational modifications and confirmation of molecular weight.

In all of these procedures, mixed samples of biological entities are applied to electrophoretic gels and the components are separated by application of an electric field across the gel. Regardless of the manner in which the gel is developed, the resulting pattern of migration of the substances contained in the sample is detected, such as by chemiluminescence or fluorescence detection.

Western blotting is one technique that involves the immobilization of proteins on membranes before detection using monoclonal or polyclonal antibodies. Prior to protein immobilization on a membrane, sample proteins are separated using SDS polyacrylamide gel electrophoresis (SDS-PAGE) to separate native or denatured proteins. The proteins are then transferred or electro-blotted onto a membrane, where they are probed and ultimately detected using antibodies specific to a target protein. The specificity of the antibody-antigen interaction can enable a single protein to be identified among a complex protein mixture.

To separate proteins that have similar molecular weights, often SDS-PAGE is carried out in a discontinuous gel, wherein a stacking gel is cast above a resolving gel. The stacking gel has a higher porosity than the resolving gel (due to the lower polyacrylamide concentration in the former), which accounts in part for the effective protein separation. The concentration of the acrylamide in the resolving gel can be varied to achieve optimal protein separation.

Systems for hand-casting an electrophoresis gel are commercially available and encompass a variety of different approaches (single, dual, multicast, etc.). Most hand-cast systems require the user to set up the system by assembling a series of variable sized glass plates with spacers appropriate to the thickness of the required gel they wish to cast (e.g., 0.75 mm, 1.0 mm, and 1.5 mm). The desired gel thickness is determined by the sample volume required for the electrophoresis process. To set up these casting systems, the glass plates are aligned properly and loaded into a holder or tank, which mechanically compresses the glass plates together and forces the glass against some means of gasketing (e.g., a silicon spacer) to prevent acrylamide liquid from leaking out of the system. The compressed glass plates form a cassette with a pocket in between the two which would be filled with liquid polyacrylamide gel before polymerizing into an electrophoretic gel.

Once the casting system has been assembled, gels may be cast by adding liquid acrylamide solutions into the glass cassette(s). Typically, polyacrylamide gels are formed from two layers: a low percentage acrylamide stacking gel to focus proteins at the gel interface and a higher percentage acrylamide resolving gel to separate proteins or other macromolecules by their molecular weight. Stacking and resolving gel solutions are comprised of some ratio of acrylamide monomer and a crosslinker, which may be bis-acrylamide. Polymerization of the acrylamide and crosslinker into a polyacrylamide gel is often achieved through the use of the chemical initiators ammonium persulfate (APS) and Tetramethylethylenediamine (TEMED). Polymerization time of the combined stacking and resolving gels is completed in 1-2 hours with this method. Alternatively, riboflavin has also been used as a polymerization initiator, often paired with TEMED as a catalyst. Riboflavin is a photoinitiator that releases free radicals upon exposure to light and complete polymerization takes up to 8 hours with this method.

Once the system has been properly assembled and set up, the first step of the casting process begins by introducing liquid acrylamide resolving gel into the cassette of glass plates, such as by pipetting. In the single and dual systems, this requires injection into a narrow opening at the top of each individual cassette. Multicast systems allow the users to flood the entire stack of cassettes simultaneously, but this produces excess acrylamide waste, which must be cleaned after the entire casting process is completed. Visibility into the cassette is crucial to achieve the desired height of the resolving gel, which is an advantage in the single and dual cassette systems but not achievable beyond the first couple of layers in a multicast system. When creating the acrylamide resolving gel formulation, ammonium persulfate (APS) and TEMED are mixed with the acrylamide to catalyze the polymerization of the gel. After injecting this liquid acrylamide formulation into the cassette(s), the user must wait 30-45 minutes for the resolving gel to completely polymerize, which is one of the largest time-sinks when creating electrophoretic gels.

Once the resolving gel has polymerized, the second step in the casting process involves introducing acrylamide stacking gel into each cassette, again such as by pipetting, on top of the resolving gel from the first step. Once the stacking gel has been introduced into the cassette, the user inserts a sample well comb matched to the gel thickness; the combs are constructed with a number of teeth to form wells, the number of which is based on sample size and desired well volumes (common configurations are 10, 12, and 15 well combs). Similar to the resolving gel formulation, the stacking gel formulation generally consist of acrylamide, APS, and TEMED but will have a different reagent concentration. With the stacking gel, the user must go through a similar waiting period of 30-45 minutes for the stacking gel to completely polymerize.

In a typical method of casting, the resolving gel solution is first added to the casting cassette and then overlaid with an alcohol to prevent oxygen inhibition of polymerization. The resolving gel is allowed to polymerize for 30-60 minutes, then the alcohol overlay is poured off, the cassette is gently rinsed with deionized water and dried, then the stacking gel solution is added to the top of the cassette and a sample well comb is inserted to form wells. The complete gel continues to polymerize for 60 minutes before it can be used or stored for later use.

It would be desirable to provide an improved polymerization process and system that in some embodiments have a simplified user workflow that reduces the waiting time, reduces the number of preparation steps, and/or reduces the number of toxic chemicals being used. It also would be desirable to provide a repeatable polymerization process and system that utilizes a gel formulation with a photoinitiator enabling polymerization with a properly selected and oriented light source.

### SUMMARY OF THE INVENTION

Embodiments disclosed herein relate to an acrylamide gel formulation for use in electrophoresis, and a system and method for electrophoretic gel casting. In some embodiments, the system comprises a light source, such as a UV-Vis curing light source, and an acrylamide formulation that allows a resolving gel and a stacking gel to be photopolymerized in a single step. In some embodiments, the acrylamide formulation allows a resolving gel and a stacking gel to be photopolymerized in more than one step. In some embodiments, the resolving solution formulation comprises acrylamide and bis-acrylamide, Bis-Tris buffering agent, an optional density adjusting agent such as sucrose or glycerol, and lithium phenyl-2, 4, 6-trimethylbenzoyl-phosphinate (LAP) as a water-soluble photoinitiator, which allows the solution to be photopolymerized using radiation within a certain wavelength. In some embodiments, a dilution buffer formulation comprises Bis-Tris buffering agent, an optional density adjusting agent such as sucrose or glycerol and lithium phenyl-2, 4, 6-trimethylbenzoyl-phosphinate (LAP) as a water-soluble photoinitiator, which allows the solution to be photopolymerized using radiation within a certain wavelength, and may or may not include acrylamide and bis-acrylamide. The dilution buffer may be added to the resolving solution in a selected amount in order to modify the concentration of the acrylamide to a desired concentration. Preferably the density adjusting agent, if used, is the same in the resolving solution and dilution buffer.

In some embodiments, the stacking solution comprises acrylamide and bis-acrylamide, Bis-Tris buffering agent and lithium phenyl-2, 4, 6-trimethyl-benzoylphosphinate (LAP) as a photoinitiator, which also allows the solution to be photopolymerized using radiation within a certain wavelength.

In some embodiments, the resolving and stacking solutions may be formulated so that the density of the resolving solution is greater than the density of the stacking solution. This allows the stacking solution to sit on top of the resolving solution (e.g., upstream of the resolving solution in the direction of sample migration when in use) when in liquid form in a gel cassette or the like. As a result, both the resolving solution and the stacking solution may be polymerized concurrently in a single step.

In certain embodiments, disclosed is an electrophoretic discontinuous gel system, comprising a resolving gel and a stacking gel, the resolving gel having been polymerized from a resolving solution formulation having a first density and comprising acrylamide and bis-acrylamide, Bis-Tris buffering agent, sucrose, and lithium phenyl-2, 4, 6-trimethylbenzoyl-phosphinate; the stacking gel having been polymerized from a stacking solution formulation having a second density and comprising acrylamide and bis-acrylamide, Bis-Tris buffering agent, and lithium phenyl-2, 4, 6-trimethylbenzoyl-phosphinate, wherein said first density is greater than said second density. In some embodiments, the electrophoretic gel system is formed by subjecting the resolving solution formulation and the stacking solution formulation to polymerization concurrently.

In other embodiments, the resolving and stacking solutions are formulated with little or no density gradient, such as by eliminating the density adjusting agent in the resolving gel, and the resolving solution and stacking solution are polymerized sequentially rather than concurrently.

In certain embodiments, the system includes a gel cassette containing the resolving solution formulation and the stacking solution formulation prior to polymerization. In certain embodiments, the system includes a gel cassette containing the resolving gel and the stacking gel after polymerization.

In some embodiments, one or both of the resolving solution and stacking solution is polymerized by a suitable light source. In some embodiments, the electrophoretic system includes the suitable light source. In some embodiments, the suitable light source comprises UV-Vis light. In some embodiments the UV-Vis light source has a wavelength of between 365 nm and 405 nm.

In some embodiments, the gel cassette is formed by two flat glass plates spaced by one or more suitable spacers, generally positioned along the perimeter of the plates, to form a volume or pocket between the plates. The thickness of the spacer(s) defines the thickness of the gel. The spacer(s) may be a separate independent component or may be integral to or bonded to one of the plates. The gel cassette functions as a gel holder to hold the gel in place during use.

In certain embodiments, disclosed is an apparatus designed for the rapid filling and polymerization of electrophoresis gels.

### BRIEF DESCRIPTION OF THE DRAWINGS

The embodiments disclosed herein may take form in various components and arrangements of components, and in various process operations and arrangements of process operations. The drawings are only for purposes of illustrating preferred embodiments and are not to be construed as limiting. This disclosure includes the following drawings:

FIG. 1 is a schematic side-view illustration of a gel cassette being irradiated with a UV light source in accordance with certain embodiments;

FIG. 2 is a perspective view of a light source and casting frame in accordance with certain embodiments;

FIG. 3 is a perspective view of a housing containing a casting frame in accordance with certain embodiments;

FIG. 4 is a perspective view of the housing of FIG. 2, showing the casting frame and gel cassette in accordance with certain embodiments;

FIG. 5 is a perspective view of a housing in accordance with an alternative embodiment;

FIG. 6 is a perspective view of a gel casting system having multiple casting assemblies in accordance with certain embodiments; and

FIG. 7 is a perspective view of a gel casting system having a dual-sided light source for gel polymerization.

### DETAILED DESCRIPTION

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise (s),” “include(s),” “having,” “has,” “can,” “contain(s),” and variants thereof, as used herein, are intended to be open-ended transitional phrases, terms, or words that do not preclude the possibility of additional components.

All ranges disclosed herein are inclusive of the recited endpoint and independently combinable (for example, the range of “from 2 inches to 10 inches” is inclusive of the endpoints, 2 inches and 10 inches, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

It should be noted that many of the terms used herein are relative terms. For example, the terms “upper” and “lower”, if used, are relative to each other in location, i.e. an upper component is located at a higher elevation than a lower component, and should not be construed as requiring a particular orientation or location of the structure. As a further example, the terms “interior”, “exterior”, “inward”, and “outward”, if used, are relative to a center, and should not be construed as requiring a particular orientation or location of the structure.

The terms “top” and “bottom”, if used, are relative to an absolute reference, i.e. the surface of the earth. Put another way, a top location is always located at a higher elevation than a bottom location, toward the surface of the earth.

The terms “horizontal” and “vertical”, if used, are used to indicate direction relative to an absolute reference, i.e. ground level. However, these terms should not be construed to require structures to be absolutely parallel or absolutely perpendicular to each other.

Turning first to FIG. 1, there is shown a schematic illustration of an exemplary system for polymerization an acrylamide gel formulation in accordance with certain embodiments. The system includes a light source 1 configured to radiate light to photopolymerize an acrylamide-based solution 2, which is held within a glass cassette assembly 3 sealed with a gasket 4 below the solution 2 and glass cassette assembly 3. The glass cassette assembly 3 may be conventional in design and construction as is known by those skilled in the art. For example, glass plates with one or more spacers appropriate to the thickness of the desired gel to be cast (e.g., 0.75 mm, 1.0 mm, and 1.5 mm) may be used. The glass plates may be aligned properly and loaded into a caster device, which functions to hold the cassette assembly and may mechanically compresses the glass plates together and force the glass against the spacer(s) or gasket(s) to prevent acrylamide liquid from leaking out of the assembly. Resolving solution, dilution buffer (if used) and stacking solution may be hand-cast into the glass cassette assembly 3 by methods well known in the art, such as by pipetting.

In accordance with certain embodiments, resolving solution and stacking solution formulations are provided that enable polymerization of both solutions in a single step. This is a significant time-saving improvement over conventional formulations that required that the resolving solution be polymerized first, thereby enabling proper orientation of the stacking solution on the resulting polymerized resolving gel prior to polymerizing the stacking solution. In some embodiments, the resolving solution formulation comprises acrylamide and bis-acrylamide, Bis-Tris buffering agent (2,2-bis(hydroxymethyl)-2,2′,2″-nitrilotriethanol), sucrose, and lithium phenyl-2, 4, 6-trimethylbenzoyl-phosphinate (LAP) as a water-soluble photoinitiator, which allows the solution to be photopolymerized using radiation within a specific wavelength range. Suitable resolving solution formulations include an acrylamide:bis-acrylamide weight ratio between 19:1 and 37.5:1. Suitable weight ratios include 19:1, 19.5:1, 20:1, 20.5:1, 21:1, 21.5:1, 22:1, 22.5:1, 23:1, 23.5:1, 24:1, 24.5:1, 25:1, 25.5:1, 26:1, 26.5:1, 27:1, 27.5:1, 28:1, 28.5:1, 29:1, 29.5:1, 30:1, 30.5:1, 31:1, 31.5:1, 32:1, 32.5:1, 33:1, 33.5:1, 34:1, 34.5:1, 35:1, 35.5:1, 36:1, 36.5:1, 37:1 and 37.5.1, as well as ratios in between any of the foregoing (e.g., 19.75:1). Preferably the total acrylamide concentration is between 8-20% w/v, the Bis-Tris concentration is between 200-375 mM, and the LAP concentration is 0.015% w/v.

The concentration of the acrylamide in the resolving solution may be customized by combining the resolving solution with a dilution buffer, wherein the dilution buffer includes a lower acrylamide concentration than the resolving solution, Bis-Tris buffering agent, sucrose or other density adjusting agent, and LAP. An exemplary dilution Buffer may have a total acrylamide concentration between 0-10% w/v, a sucrose concentration between 4-10% w/v, a Bis-Tris concentration between 200-375 mM and an LAP concentration of 0.015% w/v.

In some embodiments, the stacking solution comprises acrylamide and bis-acrylamide, Bis-Tris buffering agent and lithium phenyl-2, 4, 6-trimethyl-benzoylphosphinate (LAP) as a photoinitiator, which also allows the solution to be photopolymerized using radiation within a specific wavelength. Suitable stacking solution formulations include an acrylamide:bis-acrylamide weight ratio of 19:1, with a total acrylamide concentration between 4.5-5.5% w/v; a Bis-Tris concentration of 375 mM and an LAP concentration between 0.0015-0.05% w/v.

In this embodiment, the resolving and stacking solutions are formulated so that the density of the resolving solution is greater than the density of the stacking solution. This allows the stacking solution to sit on top of the resolving solution without mixing (e.g., upstream of the resolving solution in the direction of sample migration when in use); the denser resolving solution supports the less dense stacking solution when in liquid form in a gel cassette or the like, forming an interface between the two. As a result, both the resolving solution and the stacking solution may be polymerized concurrently or in a single step, as opposed to polymerization in two steps as has previously been done conventionally.

In certain embodiments, the density gradient between the resolving solution and the stacking solution is created by including a density adjusting agent in the resolving solution formulation. An exemplary density adjusting agent is sucrose. Suitable amounts of sucrose in the resolving solution range between 4 and 10% w/v. Another exemplary density adjusting agent is glycerol in similar amounts.

In an alternative embodiment, there is little or no density gradient between the resolving solution and the stacking solution, such as by elimination of a density adjusting agent. In this embodiment, the acrylamide formulation is comprised of the resolving solution formulation, dilution buffer formulation and stacking solution formulation except for density adjusting agent is absent.

In certain embodiments, the resolving solution and stacking solution are oriented in the glass gel cassette assembly 3 vertically, such that upon polymerization, the resulting stacking gel is above the resulting resolving gel. This orientation ensures that during electrophoresis, proteins migrate in a downward direction through the stacking gel and into the resolving gel.

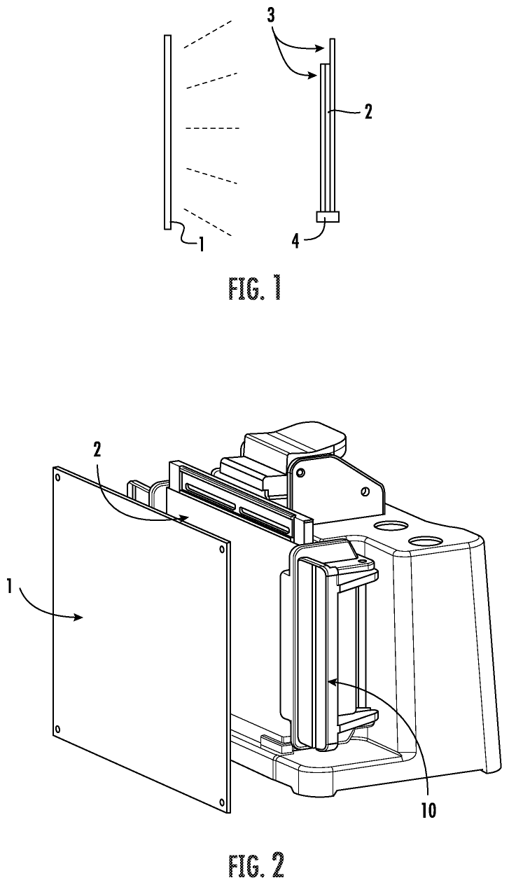

FIG. 2 illustrates an embodiment of an assembly having a light source 1, a gel cassette 2 and a casting frame 10. The light source 1 should be positioned with respect to the gel cassette 2 to achieve an optimum light intensity to effectively irradiate and polymerize the acrylamide gel solutions held in the gel cassette assembly. For optimal interaction between the radiation and polyacrylamide gel, the light must be completely unobstructed as it irradiates the gel window within the glass cassette assembly 2. Clear, transparent glass between the light and gel is the only exception. Uniformity on the surface when the light interacts with the gel should be greater than 90%. In certain embodiments, the light source should be positioned between about 1 to 3 inches from the gel cassette assembly 2. The optimal light intensity range at the aforementioned distance is between 6 mW/cm² and 23 mW/cm². The wavelength of the light source should be between 365 nm and 405 nm to activate the photoinitiator. Suitable wavelengths include 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404 and 405 nm.

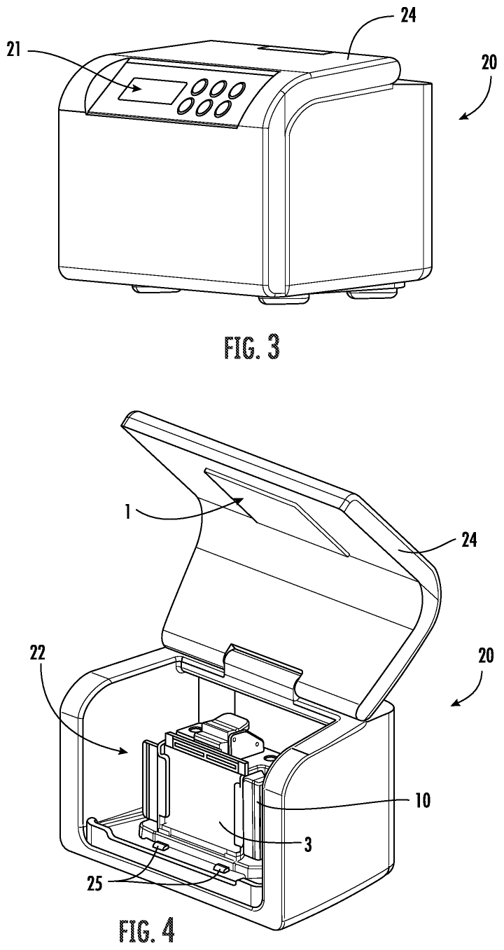

FIGS. 3 and 4 illustrate an exemplary housing 20 that may be used to contain a light source 1, such as an LED array, having the aforementioned specified light parameters and that will maintain the same position while irradiating the gel. The housing may include a controller 21 that may be placed in communication with the light source and configured to control various operational parameters, such as the time of irradiation, the intensity of the light, pulsing of the light, etc.

The controller or controllers used in any of the embodiments disclosed herein may have a processing unit and a storage element. The processing unit may be a general purpose computing device such as a microprocessor. Alternatively, it may be a specialized processing device, such as a programmable logic controller (PLC). The storage element may utilize any memory technology, such as RAM, DRAM, ROM, Flash ROM, EEROM, NVRAM, magnetic media, or any other medium suitable to hold computer readable data and instructions. The controller unit may be in electrical communication (e.g., wired, wirelessly) with one or more of the operating units in the system, including the UV light source. The controller also may be associated with a human machine interface or HMI that displays or otherwise indicates to an operator one or more of the parameters involved in operating the system and/or carrying out the methods described herein. The storage element may contain instructions, which when executed by the processing unit, enable the system to perform the functions described herein. In some embodiments, more than one controller can be used. The controller 21 may be attachable and detachable from the housing 20.

In certain embodiments, the housing 20 includes a cassette holder 22 positioned in the housing to hold the gel cassette such that the user has clear visibility of the gel during the casting operation, and has adequate hand and pipette access to the cassette during the casting operation.

In some embodiments, the housing 20 has a movable door 24, that may be movable between a closed position (FIG. 3) and an open position (FIG. 4), the latter position exposing and providing access to the gel cassette. In the embodiment of FIG. 4, the light source 1 may be coupled to the inside surface of the door 24, such that closure of the door 24 appropriately orients the light source with respect to the gel cassette, and does so in a repeatable, reproducible manner. This allows for complete light exposure to the gel without any obstruction to the light illumination. A safety mechanism may be included to prevent the light from being powered on when the door 24 is open.

In certain embodiments, a removable locating tray or platform 23 may be associated with the housing, oriented in the housing to capture chemical spillage that may occur during operation, and removable for ease of cleaning. The removable tray 23 may have locating features 25 for the placement of the gel cassette assembly and locating features (not shown) for the tray itself within the housing 20 (e.g., a magnet), to allow for repeatable, reproducible placement of the casting frame 10 and gel cassette assembly 3 in the housing.

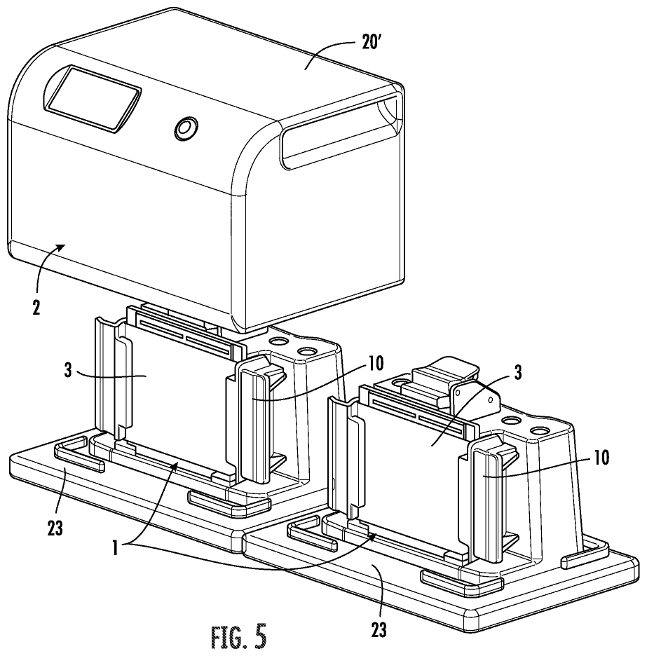

FIG. 5 illustrates an additional embodiment of a curing system. In this embodiment, the locating tray 23 and light source 1 with controls are separate entities. To create a gel using this embodiment, the housing 20 is first be removed, followed by placing the casting frame 10 with the gel cassette assembly 3 onto the tray 23 before the gel cassette is filled with the resolving and stacking gels. The housing is then placed to contain the casting frame 10, cassette assembly 3 and tray 23. Similar to the embodiment of FIG. 4, the light source may be coupled to an interior surface of the housing 20, so that when the housing is properly oriented with respect to the gel cassette assembly 3, the light source is also properly oriented. This embodiment allows for a more compact footprint and the potential to form a modular platform with the tray 23, allowing the user to fill one cassette with gel as another gel is being photopolymerized.

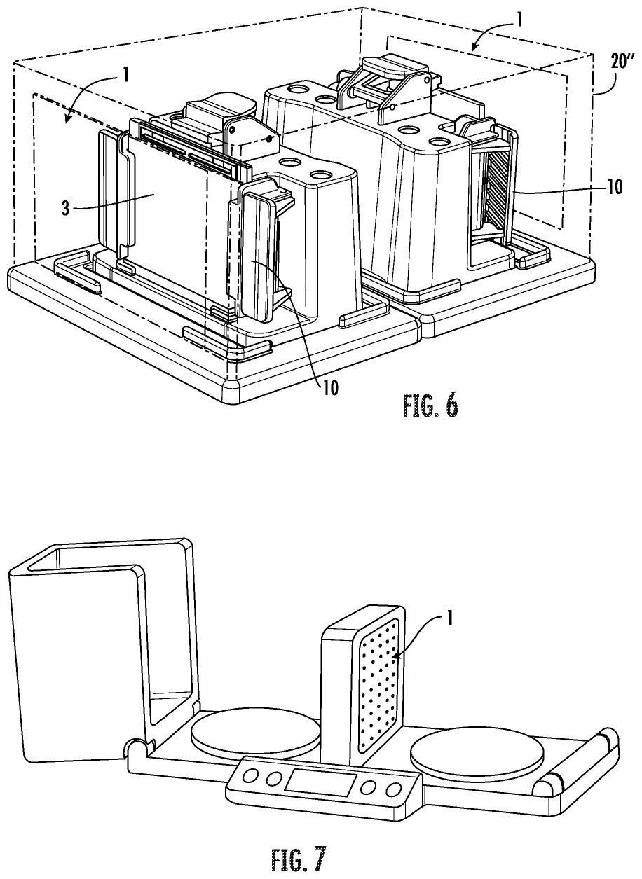

FIG. 6 illustrates a still further embodiment of a modular curing system. In this embodiment, multiple casting assemblies are oriented in back-to-back relation, each having a dedicated light source. As in previous embodiments, each light source 1 may be a single-sided panel attached to an interior wall of the housing 20″, so that upon proper positioning of the housing with respect to the gel cassette assemblies, each light source is properly oriented with respect to the gel cassette assembly to obtain optimum light illumination. In the embodiment shown, first and second light sources 1 are positioned on opposite inner walls of the housing 20″, so that the light emitted from the first light source is emitted in a direction toward the second light source.

FIG. 7 shows yet another modular embodiment. In this embodiment, multiple casting assemblies (not shown) are oriented in side-by-side relation. This allows the light source for each casting assembly to be positioned between the two assemblies as shown, such as via dual-sided light panel, each side including an array of LED lights, for example.

What is claimed is:

1. An electrophoretic gel formulation, comprising:
a. a resolving gel comprising acrylamide and bis-acrylamide, a buffering agent comprising 2,2-bis(hydroxymethyl)-2,2′,2″-nitrilotriethanol, and lithium phenyl-2, 4, 6-trimethylbenzoyl-phosphinate as a water-soluble photoinitiator; and
b. a stacking gel comprising acrylamide and bis-acrylamide, a buffering agent comprising 2,2-bis(hydroxymethyl)-2,2′,2″-nitrilotriethanol and lithium phenyl-2, 4, 6-trimethyl-benzoylphosphinate as a photoinitiator.

2. The electrophoretic gel formulation of claim 1, wherein the acrylamide:bis-acrylamide weight ratio in said resolving gel formulation is between 19:1 and 37.5:1.

3. The electrophoretic gel formulation of claim 2, wherein the total acrylamide concentration in the resolving gel formulation is between 8-20% w/v.

4. The electrophoretic gel formulation of claim 2, wherein the concentration of the buffering agent in said resolving gel formulation is between 200-375 mM, and the concentration of the photoinitiator in said resolving gel formulation is 0.015% w/v.

5. The electrophoretic gel formulation of claim 1, wherein the acrylamide:bis-acrylamide weight ratio in said stacking gel formulation is 19:1.

6. The electrophoretic gel formulation of claim 2, wherein the total acrylamide concentration in the stacking gel formulation is between 4.5-5.5% w/v.

7. The electrophoretic gel formulation of claim 2, wherein the concentration of the buffering agent in said stacking gel formulation is 375 mM and the concentration of the photoinitiator in said stacking gel formulation is 0.025% w/v.

8. The electrophoretic gel formulation of claim 1, wherein said resolving gel further comprises a density adjusting agent.

9. The electrophoretic gel formulation of claim 8, wherein said density adjusting agent is sucrose or glycerol.

10. The electrophoretic gel formulation of claim 1, wherein the acrylamide:bis-acrylamide weight ratio in said resolving gel formulation is between 19:1 and 29:1.

11. A system for polymerizing a gel formulation for electrophoresis, comprising:
a. a gel cassette configured to hold a gel formulation, the gel formulation comprising a polymerizable resolving gel solution and a polymerizable stacking gel solution, the polymerizable resolving gel solution comprising acrylamide and bis-acrylamide, a buffering agent comprising 2,2-bis(hydroxymethyl)-2,2′,2″-nitrilotriethanol, and lithium phenyl-2, 4, 6-trimethylbenzoyl-phosphinate as a water-soluble photoinitiator; the stacking gel solution comprising acrylamide and bis-acrylamide, a buffering agent comprising 2,2-bis(hydroxymethyl)-2,2′,2″-nitrilotriethanol and lithium phenyl-2, 4, 6-trimethyl-benzoylphosphinate as a photoinitiator; and
b. a light source having a wavelength between 365 and 405 nm.

12. The system of claim 11, wherein said light source is oriented with respect to said gel formulation so as to have a light intensity of between 6 mW/cm² and 23 mW/cm² at the surface of the gel formulation.

13. The system of claim 11, wherein said resolving gel solution further comprises a density adjusting agent.

14. The system of claim 13, wherein said density adjusting agent is sucrose of glycerol.

15. The system of claim 11, wherein the acrylamide:bis-acrylamide weight ratio in said resolving gel formulation is between 19:1 and 37.5:1.

16. A method of casting a gel for electrophoresis, comprising:
a. formulating a resolving gel solution comprising acrylamide and bis-acrylamide, a buffering agent comprising 2,2-bis(hydroxymethyl)-2,2′,2″-nitrilotriethanol, and lithium phenyl-2, 4, 6-trimethylbenzoyl-phosphinate as a water-soluble photoinitiator;
b. formulating a stacking gel solution comprising acrylamide and bis-acrylamide, a buffering agent comprising 2,2-bis(hydroxymethyl)-2,2′,2″-nitrilotriethanol and lithium phenyl-2, 4, 6-trimethyl-benzoylphosphinate as a photoinitiator;
wherein steps a and b are carried out such that the density of the resolving solution is greater than the density of the stacking solution;
c. introducing said resolving solution into a gel cassette;
d. introducing said stacking solution on top of said resolving solution in said gel cassette; and
e. concurrently exposing said resolving solution and said stacking solution to UV radiation at a wavelength of between 365 nm and 405 nm to polymerize the resolving solution and said stacking solution.

17. The method of claim 16, further comprising modifying the concentration of acrylamide in said resolving solution by adding to said resolving solution a dilution buffer comprising 0-10% w/v total acrylamide, 2,2-bis(hydroxymethyl)-2,2′,2″-nitrilotriethanol, sucrose, and lithium phenyl-2, 4, 6-trimethylbenzoyl-phosphinate.

18. The method of claim 16, wherein the light source irradiates said resolving solution and said stacking solution at a light intensity of between 6 mW/cm² and 23 mW/cm².

19. The method of claim 16, wherein the acrylamide:bis-acrylamide weight ratio in said resolving gel formulation is between 19:1 and 37.5:1.
